(19) United States
(12) Patent Application Publication
(10) Pub. No.: US 2008/0091642 A1
(43) Pub. Date: Apr. 17, 2008

(54) Advising the generation of a maintained index over a subset of values in a column of a table

(76) Inventors: Robert Joseph Bestgen, Rochester, MN (US); Robert Victor Downer, Rochester, MN (US); Wei Hu, Rochester, MN (US); Shantan Kethireddy, Rochester, MN (US); Andrew Peter Passe, Rochester, MN (US); Ulrich Thiemann, Rochester, MN (US)

Correspondence Address: WOOD, HERRON & EVANS, L.L.P. (IBM), 2700 CAREW TOWER, 441 VINE STREET, CINCINNATI, OH, 45202, US

(21) Appl. No.: 11/548,958

(22) Filed: Oct. 12, 2006

(51) Int. Cl. G06F 17/30

(52) U.S. Cl. 707/2

(57) ABSTRACT

An apparatus, program product and method identify a range of values in a table and advise the generation of a maintained index over the identified range of values. Additionally, a method that determines a range of values and generates a maintained temporary index is also provided. By doing so, the maintained index that was advised may be generated over the range of values in the column and used to access data in the table.

### FIELD OF INVENTION

The invention relates to database management systems, and in particular, to the optimization of database queries referencing data in tables by database management systems.

### BACKGROUND OF THE INVENTION

Databases are used to store information for an innumerable number of applications, including various commercial, industrial, technical, scientific and educational applications. As the reliance on information increases, both the volume of information stored in most databases, as well as the number of users wishing to access that information, likewise increases. Moreover, as the volume of information in a database, and the number of users wishing to access the database, increases, the amount of computing resources required to manage such a database increases as well.

Database management systems (DBMS's), which are the computer programs that are used to access the information stored in databases, therefore often require tremendous resources to handle the heavy workloads placed on such systems. As such, significant resources have been devoted to increasing the performance of database management systems with respect to processing searches, or queries, to databases.

Improvements to both computer hardware and software have improved the capacities of conventional database management systems. For example, in the hardware realm, increases in microprocessor performance, coupled with improved memory management systems, have improved the number of queries that a particular microprocessor can perform in a given unit of time. Furthermore, the use of multiple microprocessors and/or multiple networked computers has further increased the capacities of many database management systems. From a software standpoint, the use of relational databases, which organize information into formally-defined tables consisting of rows and columns, and which are typically accessed using a standardized language such as Structured Query Language (SQL), has substantially improved processing efficiency, as well as substantially simplified the creation, organization, and extension of information within a database.

Furthermore, significant development efforts have been directed toward query “optimization,” whereby the execution of particular searches, or queries, is optimized in an automated manner to minimize the amount of resources required to execute each query. In particular, a query optimizer typically generates, for each submitted query, an access plan. Such a plan typically incorporates (often in a proprietary form unique to each optimizer/DBMS) low-level information telling the database engine that ultimately handles a query precisely what steps to take (and in what order) to execute the query. Also typically associated with each generated plan is an optimizer's estimate of how long it will take to run the query using that plan. Access plans are typically stored in an access plan cache and may be reused by the optimizer.

An access plan generally includes an access method that indicates how a table referenced by a database query will be accessed to retrieve the results of the database query. Index, hash probe and/or table probe based access methods are among the most common types of access methods. Turning first to index access methods, an index is a copy of a column or columns of a table, and there are various types of indexes such as permanent indexes and sparse indexes (discussed further hereinbelow). Indexes are typically organized as a balanced tree or B-tree to facilitate searching. Specifically, via an index based access plan, an index may be searched by traversing the B-tree structure until results satisfying the criteria of the database query are reached. A hash probe based access method typically includes hashing a key for values of a table and subdividing the keys into buckets to form a hash table. Each bucket contains the key and value pairs. Thus, via a hash probe based access method, a key may be hashed for values that satisfy the criteria of the database query to find the appropriate bucket and the bucket is searched for the right key and value pairs. A hash table may also be indexed. A table probe or table scan based access method typically includes searching each row of a column of a table for values that satisfy the criteria of a database query.

Some database systems allow storing the results of a query, and returning those results when the query is repeated. While this speeds up the execution of the query, the stored results may be stale due to changes in the database that were made since the last time the query was run. As a result, some applications require “live data”, which means the database must be queried each time, thereby eliminating any performance improvement that might otherwise result from using previously-retrieved result sets. As such, indexes may be created and used in the access plans to speed the execution of a query. The use of indexes becomes even more important when live data is required. The indexes that may be built for live data are often referred to as sparse indexes.

Sparse indexes are typically built over the entire selection (i.e., the where clause) of database queries. This is problematic because oftentimes multiple queries reference the same column in a table (e.g., tableT.columnx=‘const’, tableT.columnx=JoinTable.columnx) but not the same selection. As the selection is built into sparse indexes (e.g., where Table.columny=‘red’), unless the same selection arises in another query, it is difficult to reuse a sparse index. Thus, sparse indexes are typically not maintained nor reused or shared by multiple database queries. Instead, a sparse index may only be available as long as the query for which it was created is available.

The organization of a table referenced by a database query may also affect optimization. For example, some tables may be partitioned whereas other tables may not be partitioned. Partitioning may be performed for a variety of reasons, usually, it is performed on very large tables as a way to break the data into subsets of some conveniently workable size. By dividing a table into partitions, improved execution efficiency may result as an optimizer can work with a smaller portion of the table instead of the whole table.

However, not all tables are partitioned, for example, due to the overhead required to partition a table. As such, retrieving data from a non-partitioned table may be costly. As an example, an index such as a permanent index may need to be generated before it can be utilized. Permanent indexes must be built over an entire column of a table, and as such, may be very costly to create and use. The benefit of a permanent index is only realized when the index is revised multiple times after it has been initially created. However, in cases where a permanent index is not available, the optimizer may have to choose an expensive hash probe based access plan or a table probe based access plan. The larger the table, the more resources may be wasted to complete such probes. Thus, conventional techniques for non-partitioned tables may be inefficient and/or costly.

A need therefore exists for an improved manner of optimizing a database query referencing a table.

### SUMMARY OF THE INVENTION

The invention addresses these and other problems associated with the prior art by providing an apparatus, a program product, and a method that identify a range of values in a table and advise the generation of a maintained index over the identified range of values. By doing so, the maintained index that was advised may be generated over the range of values and used to access data in the table, often leading to less expensive and/or more efficient data access methods and/or reduced CPU utilization and/or a reduced IO footprint.

Consistent with one aspect of the invention, a range of values may be identified, wherein the range of values is a subset of values in a column of a table, and generation of a maintained index over the identified range of values may be advised. Consistent with another aspect of the invention, a range of values in a column in a table over which to generate a maintained index may be determined, where the range of values is a subset of the values in the column, and a maintained index over the identified range of values may be generated.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF THE DRAWINGS

FIG. 1 is a block diagram of a networked computer system incorporating a database management system within which is implemented index advisement consistent with the invention.

FIG. 2 is a block diagram illustrating the principal components and flow of information therebetween in the database management system of FIG. 1.

FIG. 3 is a flow chart of an index advisement routine consistent with the principles of the present invention.

### DETAILED DESCRIPTION

The embodiments discussed hereinafter identify a range of values in a table and advise the generation of a range partitioned maintained index (RPMI) over the identified range of values. The range of values may be a subset of the values in a column of the table. A range partitioned maintained index is a maintained index that is “range partitioned” to the extent that the index covers only a range, or subset, of values present in a column (i.e., the identified range of values) over which the maintained index is created.

The embodiments discussed below are specifically directed to advising the generation of an RPMI on a non-partitioned table. However, one of ordinary skill in the art will appreciate that the invention may also be utilized in connection with partitioned tables, e.g., to advise the generation of an RPMI on a range or subset of values from a column defined in a partition of a partitioned table. The adaptation of the techniques described herein to advise the generation of RPMI's on partitioned tables would be within the abilities of one of ordinary skill in the art having the benefit of the instant disclosure.

One of ordinary skill in the art will also appreciate that an RPMI can be maintained permanently (e.g., as long as the column of the non-partitioned table exists) or less than permanently (e.g., temporarily such as for a duration of time during which queries will be accessing data from a particular column, for example, for the fiscal year of 2005, the first quarter of 2006, etc.). An RPMI may be implemented, for example, as a maintained temporary index, e.g., similar to the maintained temporary indexes described in U.S. patent application Ser. No. 11/388,004, filed by Bestgen et al. on Mar. 23, 2006, which is incorporated herein by reference. The reader's attention is also directed to U.S. patent application Ser. No. 11/379,503, filed by Bestgen et al. on Apr. 20, 2006, which is also incorporated herein by reference.

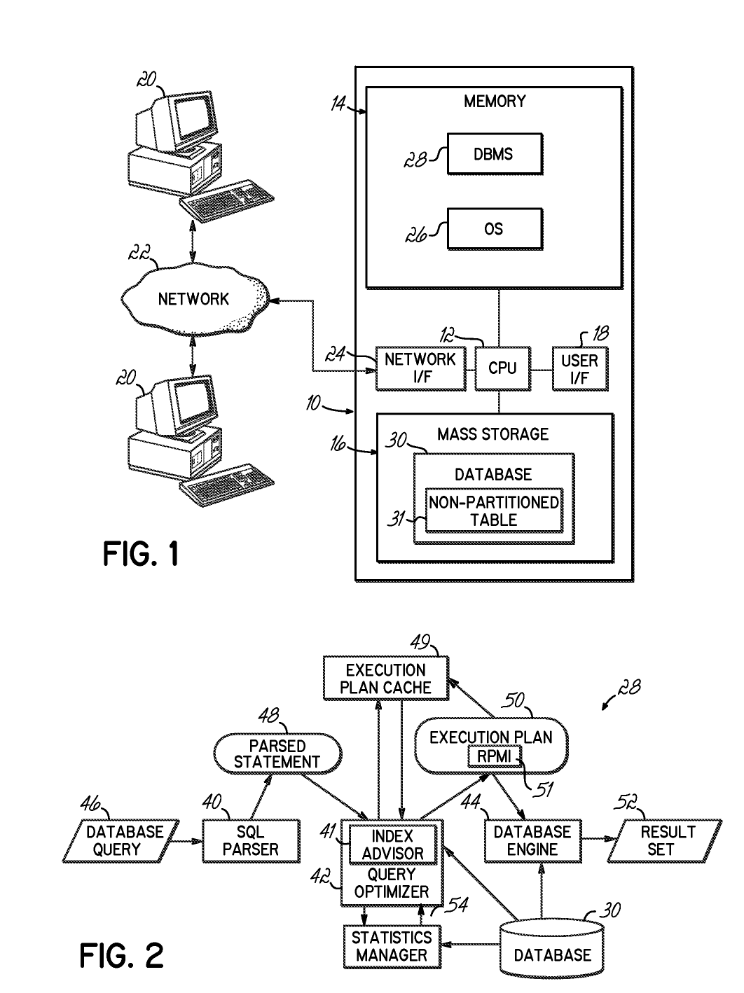

Turning now to the Drawings, wherein like numbers denote like parts throughout the several views, FIG. 1 illustrates an exemplary hardware and software environment for an apparatus 10 suitable for implementing a database management system incorporating index advisement consistent with the invention. For the purposes of the invention, apparatus 10 may represent practically any type of computer, computer system or other programmable electronic device, including a client computer, a server computer, a portable computer, a handheld computer, an embedded controller, etc. Moreover, apparatus 10 may be implemented using one or more networked computers, e.g., in a cluster or other distributed computing system. Apparatus 10 will hereinafter also be referred to as a “computer,” although it should be appreciated that the term “apparatus” may also include other suitable programmable electronic devices consistent with the invention.

Computer 10 typically includes a central processing unit (CPU) 12 including one or more microprocessors coupled to a memory 14, which may represent the random access memory (RAM) devices comprising the main storage of computer 10, as well as any supplemental levels of memory, e.g., cache memories, non-volatile or backup memories (e.g., programmable or flash memories), read-only memories, etc. In addition, memory 14 may be considered to include memory storage physically located elsewhere in computer 10, e.g., any cache memory in a processor in CPU 12, as well as any storage capacity used as a virtual memory, e.g., as stored on a mass storage device 16 or on another computer coupled to computer 10.

Computer 10 also typically receives a number of inputs and outputs for communicating information externally. For interface with a user or operator, computer 10 typically includes a user interface 18 incorporating one or more user input devices (e.g., a keyboard, a mouse, a trackball, a joystick, a touchpad, and/or a microphone, among others) and a display (e.g., a CRT monitor, an LCD display panel, and/or a speaker, among others). Otherwise, user input may be received via another computer or terminal, e.g., via a client or single-user computer 20 coupled to computer 10 over a network 22. This latter implementation may be desirable where computer 10 is implemented as a server or other form of multi-user computer. However, it should be appreciated that computer 10 may also be implemented as a standalone workstation, desktop, or other single-user computer in some embodiments.

For non-volatile storage, computer 10 typically includes one or more mass storage devices 16, e.g., a floppy or other removable disk drive, a hard disk drive, a direct access storage device (DASD), an optical drive (e.g., a CD drive, a DVD drive, etc.), and/or a tape drive, among others. Furthermore, computer 10 may also include an interface 24 with one or more networks 22 (e.g., a LAN, a WAN, a wireless network, and/or the Internet, among others) to permit the communication of information with other computers and electronic devices. It should be appreciated that computer 10 typically includes suitable analog and/or digital interfaces between CPU 12 and each of components 14, 16, 18, and 24 as is well known in the art.

Computer 10 operates under the control of an operating system 26, and executes or otherwise relies upon various computer software applications, components, programs, objects, modules, data structures, etc. For example, a database management system (DBMS) 28 may be resident in memory 14 to access a database 30, which may contain a non-partitioned table 31, resident in mass storage 16. Moreover, various applications, components, programs, objects, modules, etc. may also execute on one or more processors in another computer coupled to computer 10 via a network, e.g., in a distributed or client-server computing environment, whereby the processing required to implement the functions of a computer program may be allocated to multiple computers over a network.

In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable media used to actually carry out the distribution. Examples of computer readable media include but are not limited to tangible recordable type media such as volatile and non-volatile memory devices, floppy and other removable disks, hard disk drives, magnetic tape, optical disks (e.g., CD-ROMs, DVDs, etc.), among others, and transmission type media such as digital and analog communication links.

In addition, various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

Those skilled in the art will recognize that the exemplary environment illustrated in FIG. 1 is not intended to limit the present invention. Indeed, those skilled in the art will recognize that other alternative hardware and/or software environments may be used without departing from the scope of the invention.

FIG. 2 next illustrates in greater detail the principal components in one implementation of DBMS 28. The principal components of DBMS 28 that are generally relevant to query execution are a Structured Query Language (SQL) parser 40, query optimizer 42 and database engine 44. SQL parser 40 receives from a user (or more typically, an application executed by that user) a database query 46, which in the illustrated embodiment, is provided in the form of an SQL statement. SQL parser 40 then generates a parsed statement 48 therefrom, which is passed to optimizer 42, which may contain an index adviser 41, for query optimization. As a result of query optimization, an execution or access plan 50, which may utilize an RPMI 51, is generated. Once generated, the execution plan is forwarded to database engine 44 for execution of the database query on the information in database 30. The plan may also be stored in the execution or access plan cache 49. The result of the execution of the database query is typically stored in a result set, as represented at block 52.

To facilitate the optimization of queries, DBMS 28 may also include a statistics manager 54. Statistics manager 54 may be used to gather, create, and analyze statistical information used by the query optimizer 42 to select an access plan. The query optimizer 42 may also store, update, and/or retrieve information from an execution plan cache or access plan cache 49.

In the context of the invention, upon receiving a query referencing a non-partitioned table, the query may be processed and sent to query optimizer 42. If there is an access plan 50 in the access plan cache 49 that can be used to execute the query, that plan may be reused. Otherwise, an index selection strategy may be pursued. As such, the index adviser 41 may analyze the query (e.g., the predicate(s) of a query) to identify a range of values in a column in the non-partitioned table referenced by the query. A range of values consistent with the invention may include practically any set of values in a column of a non-partitioned table. and is typically only a subset of all of the values found in that column. The range of values may be “identified” via an analysis of the query. As such, the range of values may be automatically determined by the system by analyzing the query. On the other hand, the range of values may be determined manually by a user. In this case, the user may input the range of values into the system and the system may then identify or determine this input to be the range of values and advise generation of an RPMI and/or generate an RPMI over this range of values. Identifying and/or determining the range of values may also be accomplished by analyzing multiple database queries and amortizing (discussed further below) and/or performing generation analysis (discussed further below).

As indicated above, in some embodiments, the non-partitioned table may be analyzed to identify the range of values. Furthermore, in some embodiments, multiple queries may be analyzed to identify a range of values suitable for use by multiple queries, and as a result, the identified range may not be the same as a range identified by any one query. The identified range of values may be a subset of the selection of a query. However, after the analysis, the identified range of values may be the entire selection of a query. The range of values may be a numerical range (e.g., dates such as 2004 to 2005 or 2004 to 2006, dates x1>x2, etc.), non-numerical range (e.g., customer name such as jones to smith, customer y1>y2, etc.), a combination of a numerical and a non-numerical range, etc.

Based upon this analysis, the index adviser 41 may advise the generation of a RPMI to the optimizer 42 over the identified range of values to use to execute the query. Advising the generation of a RPMI may include performing generation analysis. Generation analysis may include amortization analysis, non-partitioned table analysis, and/or cost analysis. In particular, generation analysis may be the analysis of other types of data, e.g. the non-partitioned table, the database query, the advised RPMI for the query, another advised RPMI for another query, access patterns, amortization analysis, a combination of two or more of these, etc. For example, if the selection of the database query references 500 values in a column of the non-partitioned table and the column of the non-partitioned table only has those 500 values, then it may not be worthwhile advising generation of a RPMI.

Next, the query optimizer 42 may determine whether to generate an advised RPMI based upon generation analysis. The query optimizer 42 may determine whether to generate an advised RPMI from multiple advised RPMI's or from only one advised RPMI. Such generation analysis techniques may include analysis techniques used in determining whether to generate other types of indexes, e.g. permanent indexes. As indicated above, the generation analysis may also include analysis of other types of data, e.g. the non-partitioned table, the database query, the advised RPMI for the query, another advised RPMI for another query, and/or amortization analysis.

If the optimizer determines that the advised RPMI should not be generated, the optimizer 42 may amortize the advised RPMI and any other RPMI's covering that range of values by updating counters for these advised RPMI's in the access plan cache 49. In particular, the mapping of ranges of values may be stored with the corresponding database queries in the access plan cache 49 as well as the amortization values from the counters of the advised RPMI's (discussed further hereinbelow). Although the access plan cache 49 may be utilized to aggregate data and to anchor the amortization, such need not be the case in some embodiments.

If an RPMI is to be generated, the RPMI may be generated by the optimizer 42 and an access plan 50, with the RPMI 51, may be utilized to execute the database query. In particular, the access plan 50 is associated with the query optimized object (QOO), i.e., the output of the optimizer 42, and the database engine 44 executes the query execution object (QEO) to produce result set 52. Next, the optimizer may store the chosen access plan 50 in the access plan cache 49. As such, the optimizer 42 will optimize the query with the plan and may update the access plan cache 49 to remove the range of values over which the RPMI was generated from other advised RPMI's in the access plan cache 49.

Those of ordinary skill in the art will also recognize that the exemplary implementation of DBMS 28 illustrated in FIG. 2 is not intended to limit the present invention. It will be appreciated by those of ordinary skill in the art that optimizer 42, index adviser 41, database engine 44, and/or access plan cache 49, as well as others, may be accorded different functionality in other embodiments consistent with the invention. For instance, in some embodiments, the query may be analyzed by an SQL Query Engine (SQE), which may be used to refer to the optimizer as well as the database engine, instead of an index adviser. Moreover, components may be added and/or omitted in other embodiments consistent with the invention. Indeed, those skilled in the art will recognize that other alternative hardware and/or software environments may be used than those depicted in FIGS. 1 and 2 without departing from the scope of the invention.

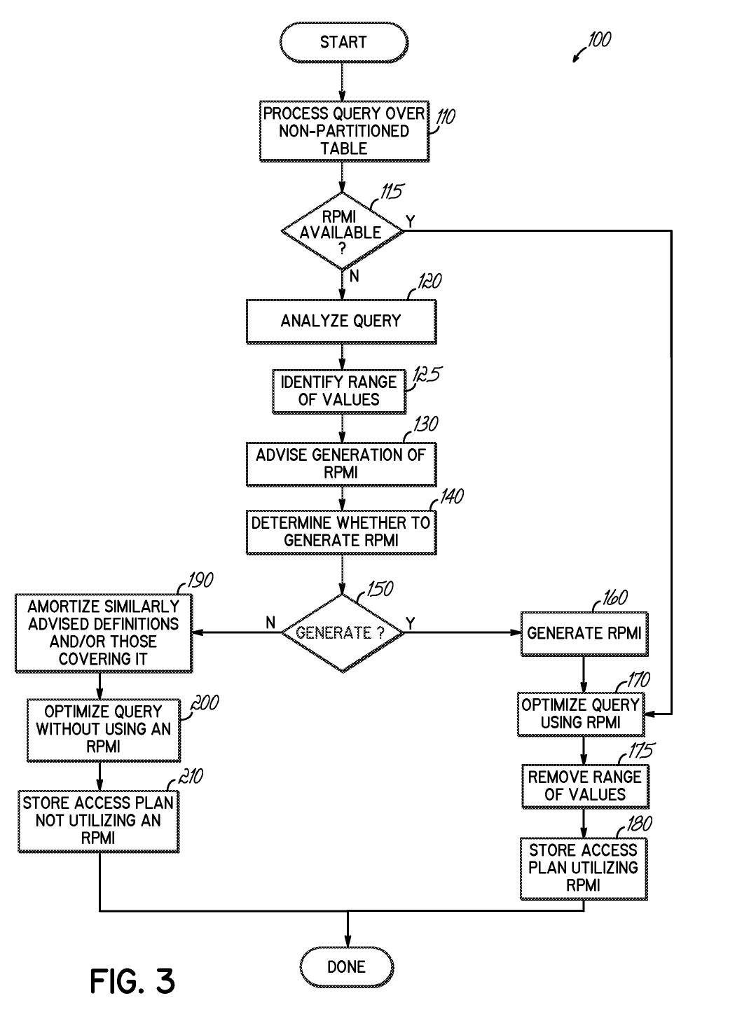

Turning now to FIG. 3, FIG. 3 illustrates an exemplary index advisement routine 100 consistent with the principles of the present invention. Routine 100 may be executed during the optimization of a database query. For example, new code may be added to traditional optimization techniques to detect instances where an optimizer may not generate an index on a particular non-partitioned table because of the size of the non-partitioned table (e.g., the size of the non-partitioned table is large).

Starting with block 110 of routine 100, block 100 processes a portion of a database query over a non-partitioned table. Next, block 115 determines whether or not there is a RPMI available for the relevant column of the table. In particular, those of ordinary skill in the art may appreciate that after multiple iterations of routine 100, a RPMI may have been generated, and may be reused by subsequent database queries referencing data in the range of values in the column that the RPMI was generated over. If a RPMI is available, control may pass to block 170 to optimize the query using the RPMI. Optimizing the query may include generating an access plan that utilizes the RPMI to access the data in the non-partitioned table.

Next, control may optionally pass to block 175 to update the access plan cache to remove the range of values over which the RPMI was generated to ensure that the advised RPMI's in the access plan cache no longer contain a range of values that has already been generated. Removing the range of values typically ensures that resources are not wasted generating an additional RPMI when an RPMI already exists for that range of values.

Next, block 180 stores the access plan, which utilizes the RPMI. The access plan may be stored in the access plan cache. By reusing the RPMI, the data may be accessed without using a hash probe or a table probe, generally reducing the CPU utilization and the IO footprint. Routine 100 is then complete.

Returning back to block 115, if a RPMI is not available, control may pass to block 120 to analyze the query. Block 120 may analyze a query by determining the predicate structure of the query such as the operators (e.g., >, <, etc.), the range of values or ranges of values referenced in the database query (e.g., Table.c1 between 1 and 100, Table.c1 between 150 and 1500), etc. Furthermore, in some embodiments, other factors may be analyzed besides the text of the query such as the non-partitioned table, min/max size of each range of values, etc. to identify a range of values. For example, if a non-partitioned table has one million records, a division can be used such as one million divided by one hundred, to generate RPMI's that are of the same number of records. This may facilitate aggregation of RPMI's to execute future queries.

Next, block 125 identifies one or more ranges of values, which may have been determined in block 120 during the analysis of the query. Based on the analysis of the database query, block 130 may advise the generation of a RPMI on any identified range of values. Additionally, in some embodiments, multiple RPMI's may be advised, for example, when the column is very large and/or a large amount of data may be needed to execute the query (e.g., fifty million rows). For instance, multiple ranges of values may be identified in block 125 and the generation of an RPMI may be advised for some or all of these identified ranges of values. Alternatively, the range of values identified in block 125 may be further divided and multiple smaller RPMI's may be advised for all or some of these smaller ranges of values. The smaller ranges of values may be bounded by the identified range of values, for instance from block 125.

Next, block 140 determines whether to generate an advised RPMI. In particular, block 140 may perform a generation analysis and the determination may be based upon this analysis. It is worth noting that other advised RPMI's from previous iterations of routine 100 for other database queries may be stored in the access plan cache. Moreover, these previously advised RPMI's as well as the RPMI advised in block 130, among other criteria, may be analyzed in block 140 to determine whether to generate an advised RPMI, either to generate the advised RPMI from block 130 or to generate a previously advised RPMI from a previous iteration of routine 100.

As indicated hereinabove, practically any aspect associated with an advised RPMI may be used in generation analysis. Thus, generation analysis may include analysis of the non-partitioned table, the database query, the advised RPMI for the query, another advised RPMI for another query, etc. In particular, generation analysis may rely upon amortization analysis (e.g., comparing the amortization value of an advised RPMI to another amortization value of another advised RPMI, comparing an amortization value of an advised RPMI to a threshold value, determining which advised RPMI has the highest amortization value, etc.), non-partitioned table analysis (e.g., distribution of the non-partitioned table, the size of the non-partitioned table, skew, cardinality, etc.), and/or cost analysis (e.g., IO's, CPU utilization, the minimum and maximum size of each advised RPMI to ensure that the size does not exceed preset tolerances, etc.). Generation analysis may also be other type of analysis consistent with the principles of the present invention. Those of ordinary skill in the art may appreciate that the non-partitioned table may be analyzed, for example, to avoid RPMI's over the entire column or majority of the column as this may have the same shortcomings as permanent indexes over the entire column.

Additionally, generation analysis may include other types of analysis, e.g., analysis of the database query such as the local selection predicate const values. Furthermore, the ranges of values of the advised RPMI's, the number of records in the advised RPMI's, etc. may also be taken into account.

Returning to block 140, block 140 determines whether to generate a RPMI based upon generation analysis. In particular, block 140 may perform generation analysis by searching through the access plan cache for a previously advised RPMI for the same identified range of values from block 125 or a previously advised RPMI with a range of values that includes (i.e., covers) the identified range of values from block 125. If the range of values that was identified in block 125 and for which generation of an RPMI over that identified range of values was advised in block 130 has not been previously advised, a generation analysis for the generation of the advised RPMI for this identified range of values may still be performed. In particular, the cost of generating the advised RPMI of block 130 may be determined and compared to a maximum cost value, which may be configurable.

If the advised RPMI from block 130 has been previously advised either identically or covered based upon a search of the access plan cache, then the amortization value of each of these advised RPMI's may be examined and one of the advised RPMI's may be selected. In particular, the advised RPMI with the highest amortization value via amortization may be selected or an advised RPMI whose amortization value has met or exceeded a threshold may be selected. An amortization value for an advised RPMI may be illustrative of the number of times the range of values or subset of the range of values of the RPMI have been advised and may be expressed via a counter that is updated each time that RPMI is advised (discussed further in connection with block 190). Moreover, the non-partitioned table may be analyzed (e.g., to compare the size of the non-partitioned table to the size of the advised RPMI). Furthermore, the cost of generating the advised RPMI selected in block 140 may be determined and compared to a maximum cost. After the selection, conventional costing algorithms may be utilized to estimate the amount of CPU utilization, estimate the number of IO's, page size, etc. approximately required to generate the advised RPMI selected.

To elaborate further, the determination of whether to generate an advised RPMI (e.g., the advised RPMI from block 130 or advised RPMI selected in block 140) in block 140 may be based upon a maximum cost value. The cost of generating an advised RPMI may include both the generation costs and the consumption costs (i.e., accessing the data in the non-partitioned table utilizing the RPMI). If the generation cost is below a maximum cost value and the amortization value reflected in a counter used for amortization has met or exceeded a threshold, then the cost of generating the advised RPMI is not high, so block 150 may indicate that the advised RPMI should be generated, and control may pass to block 160 to generate the advised RPMI and optimize the query using the generated RPMI.

However, an advised RPMI does not necessarily have to be amortized to meet a threshold in order to be generated. For instance, when the cost of generating an advised RPMI is low enough, even though this is the first time that RPMI has been advised, or when the advised RPMI is deemed of high importance based on amortization (e.g., high amortization value but amortization value has not met a threshold), an advised RPMI may nonetheless be generated, especially if a RPMI plan is the best plan to execute the database query. Thus, block 150 would indicate that generation should proceed, and control passes to block 160.

Returning to block 150, if it is determined based upon generation analysis (e.g., costs too high, amortization value has not met threshold, etc.) that an RPMI should not be generated, control passes to block 190. Block 190 amortizes similarly advised definitions (e.g., ranges of values), for example, previously advised RPMI's in the access cache plan with a range of values identical or similar to that of the advised RPMI of block 130, or previously advised RPMI's in the cache that have ranges of values that cover that of the advised RPMI of block 130. If encountered for the first time, a counter may be started for the advised RPMI of block 130 in the access plan cache. Next, block 200 optimizes the database query to generate an access plan that does not utilize a RPMI. Instead, the access plan may utilize a permanent index over the entire column referenced by the query, or may use a table probe or hash probe based access method for the table. Control then passes to block 210 to store the access plan, whereby routine 100 is complete.

It is worth noting that the access plan cache is one method for anchoring this amortization data, however, practically any sort of map that collects RPMI data may be utilized.

Those of ordinary skill in the art may appreciate that various modifications may be made to routine 100 consistent with the invention. For example, an alternative implementation of routine 100 may simply run through an indexing selection strategy for a given non-partitioned table for the index adviser to advise RPMI(s). If the cost of generating the advised RPMI(s) is too high, the access plan cache may be searched to find matching RPMI's (or containing the RPMI's) in order to determine its current amortization value. Based on the search, if the amortization value is high enough for an RPMI and the cost of generating the RPMI is below a maximum cost value, then the RPMI may be generated, especially if an RPMI based access plan costs the best for executing the query.

This same or similar process may be performed for any range of values over which to advise generation of an RPMI, but an RPMI does not need to be generated for other advised RPMI's just because one advised RPMI is generated. An index selection strategy may be utilized to determine whether or not to generate additional RPMI's, and a technique such as index advising may be utilized to merge RPMI's. Similarly, if an index over the entire column is needed, one of ordinary skill in the art will appreciate that multiple RPMI's may be combined to form a union. As such, the creation of a separate permanent index over the column may be avoided. Nonetheless, once a RPMI is generated, the advised RPMI's in the access plan cache may be updated to remove the range of values over which the RPMI was generated.

As described above, one of ordinary skill in the art will appreciate that the determination in block 140 of whether to generate a RPMI may be for a previously advised RPMI during a previous iteration of routine 100 for a different database query referencing the non-partitioned table. Thus, it is contemplated within the scope of the present invention to generate an RPMI for the identified range of values of block 125 for which an RPMI was advised in block 130 or for any other previously advised RPMI, for example, from the access plan cache.

To further illustrate the operation of routine 100, consider an example where a non-partitioned table named Fact contains one billion records with Fact.Columnx having values 1 to 1,000,000,000 (i.e., 1 billion). Upon receiving a Query1, the Query1 may be analyzed and it may be determined that a predicate of Query1 references a range of values in Fact.Columnx of between 1 and 500. Due to the size of the table, a an index over the entire table may not be considered by conventional techniques as part of an access plan to satisfy Query1. However, according to the principles of the present invention, the index adviser may advise the generation of an RPMI over Fact.Columnx for the range 1 to 500, or for another similar range of values.

Next, generation analysis may be performed to determine whether to generate the advised RPMI. In particular, the access plan cache may be searched to determine if an RPMI covering the range 1 to 500 has been previously advised either identically or as part of a range of values of another advised RPMI that covers it. Amortization values of these RPMI's may be examined, and conventional costing algorithms may be performed. Additionally, the non-partitioned table may analyzed to determine the size of the Fact table, the distribution of the data in the Fact table, the cardinality (i.e., number of unique occurrences), skew, active entries, etc.

If the cost is low enough, even if an RPMI for the range of values 1 to 500 has not been previously advised nor amortized, the optimizer may generate an RPMI over the range 1 to 500. However, assuming the costs are high and that the RPMI for the identified range of values 1 to 500 is advised for the first time, a counter can be started for the advised RPMI for the range of values 1 to 500 such as Amortization_counter=1. Nonetheless, the optimizer may optimize Query1 with an access plan that does not utilize an RPMI to retrieve the results for Query1. The access plan may instead use a conventional permanent index over the billion rows of Columnx of the Fact table or a maintained index with selection built into it or a table probe or hash probe against the billion rows of the Fact table. The advised RPMI with the identified range of values of 1 to 500 and the access plan may all be saved in the access plan cache along with Query1.

Next, another query (Query2) may be processed and the analysis of Query2 may reveal that it has a predicate referencing a range of values in the Fact.Columnx of between 1 and 100. The index adviser may advise the generation of an RPMI over Columnx for the range of values 1 to 100. Generation analysis may lead to the conclusion that this is the first time the range of values 1 to 100 is encountered, however, there is a previously advised RPMI for the range of values 1 to 500 from Query1 with Amort_counter1=1 (i.e., RPMI Fact.Columnx ranges(1,500)) Amort_counter1=1), that covers the newly identified range of values from Query2 (i.e., the range of values 1 to 100 are included in the range of values 1 to 500).

Additionally, traditional costing algorithms may be utilized to determine if the cost of generating an RPMI for the range of values 1 to 100 is low enough or if the range of values 1 to 100 is deemed of high importance based on amortization, even if a threshold has not yet been reached. For instance, the cost of generating a RPMI for the identified range of values in the access plan cache with the highest counter may not be too high, and even though the amortization value of the counter has not reached a threshold, if the cost of generation a RPMI for that range is not high, it may be generated in some embodiments consistent with the invention. If such is the case, a RPMI may be generated for the range of values 1 to 100. Moreover, the range of values 1 to 100 may be removed from the previously advised RPMI for the range of values 1 to 500. As such, that previously advised RPMI may be changed to 101 to 500 as an RPMI now exists for the range 1 to 100 of Fact.Columnx.

However, if the costs are too high to generate an RPMI for the range of values 1 to 100, the advised RPMI for the range of values 1 to 100 may similarly be stored in the access plan cache. A counter may also be started for this range (i.e., RPMI Fact.Columnx ranges(1,100)) Amort_counter2=1). Additionally, the counter for the advised RPMI for the range 1 to 500 may also be updated as the range of values 1 to 100 is covered by range 1 to 500 (i.e., RPMI Fact.Columnx ranges(1,500)) Amort=2). As such, a RPMI may not be generated during this iteration either and the optimizer may optimize Query2 with an access plan that does not utilize a RPMI to retrieve the results for Query2 as above.

Next, assume that Query1 is processed in reusable mode, executed 98 more times, and processed as above (i.e., so that RPMI Fact.Columnx ranges(1,500)) Amort_counter1=100). At this point, the range of values 1 to 500 may again be identified and generation of a RPMI over this range may again be advised. However, in determining whether to generate the advised RPMI for the range of values 1 to 500, it may be determined that the advised RPMI has been advised 100 times and the threshold is 100, thus it has met the threshold. Furthermore, the distribution of the Fact table may be utilized to determine the uniformity of the Fact table, which may be deemed fairly uniform as cardinality in this case is the same as the Active entries. Moreover, the size of the RPMI may be estimated to be 500 records, which may not be too large when compared to the size of the column. Additionally, CPU utilization may not be as high to generate the advised RPMI. Thus, since the amortization value has met the threshold, the non-partitioned table has been analyzed, and the costs are not too high when compared to a maximum value to generate this RPMI for the range of values 1 to 500, the optimizer may generate the RPMI and reoptimize Query1 with the generated RPMI. If the costs are high, however, the RPMI may not be generated even though the threshold has been met. Instead, in some embodiments, a different advised RPMI may be generated for a different identified range of values, for example, from a query3, that covers this range of values of 1 to 500 with lower costs but whose amortization value has not met the threshold.

Nonetheless, if an advised RPMI is generated, the range of values 1 to 100 in the access plan cache may be removed as there is now a RPMI that covers that the range of values 1 to 100. Thus, the advised RPMI from Query2 may be completely removed from the cache. Additionally, if Query1 or Query2 is received once again by the optimizer, or any other query with a range of values in 1 to 500, the RPMI generated for the range of values 1 to 500 may be used to optimize to the query and access the data rather than a traditional permanent index over the entire column, table probe, and/or hash probe.

Moreover, unlike sparse indexes, the embodiments discussed herein approach the generation of indexes more intelligently. In particular, the embodiments discussed herein analyze a database query to identify a range of values, advise the generation of a RPMI over an identified range of values, utilize generation analysis to determine which advised RPMI to generate and/or generate RPMI's. Moreover, this may possibly minimize the need to load the entire non-partitioned table and/or a permanent index over an entire column of the non-partitioned table into memory. Instead, a smaller generated RPMI may be brought into memory to execute a database query.

In particular, those of ordinary skill in the art may appreciate that a query may be analyzed to identify a range of values for which generation of an RPMI can be advised over and to determine whether to generate an RPMI via costing or to defer the generation until a range of values is amortized to a defined point (i.e., a threshold). Specifically, those of ordinary skill in the art may appreciate that amortization may be utilized to generate an RPMI with a range of values hard coded into the generated RPMI that covers many queries; thus, the generated RPMI may be the most beneficial to execute multiple queries. Furthermore, RPMI's may be combined. Nonetheless, specifically, after the counter of an advised RPMI meets a threshold, and the cost of creating the RPMI is under a defined maximum cost value (e.g., generate cost only, a combination of generate cost and consumption cost, etc.), the RPMI may be generated. Once generated, during future iterations, the optimizer may rely on the consumption cost of utilizing the RPMI alone to execute database queries when comparing the cost of different access plans.

Various modifications may be made to the illustrated embodiments without departing from the spirit and scope of the invention. Therefore, the invention lies in the claims hereinafter appended.

What is claimed is:

1. A computer implemented method of advising a range of values in a column in a table over which to generate a maintained index, the computer implemented method comprising:
a) identifying a range of values, wherein the range of values is a subset of values in a column of a table; and
b) advising generation of a maintained index over the identified range of values.

2. The computer implemented method of claim 1, wherein the table is a non-partitioned table, the method further comprising generating a maintained index over the identified range of values.

3. The computer implemented method of claim 2, wherein identifying the range of values includes analyzing a database query referencing the table, wherein the database query specifies the identified range of values.

4. The computer implemented method of claim 1, wherein advising generation of a maintained index over the identified range of values includes performing generation analysis.

5. The computer implemented method of claim 1, further comprising identifying a second range of values, wherein the second range of values is a subset of values in the column of the table and advising generation of a maintained index over the identified second range of values.

6. The computer implemented method of claim 5, wherein identifying the range of values includes analyzing a second database query referencing the table, wherein the second database query specifies the identified second range of values.

7. The computer implemented method of claim 5, further comprising determining whether to generate at least one maintained index over at least a portion of one of the first and second identified ranges of values based upon generation analysis.

8. The computer implemented method of claim 5, further comprising generating a maintained index over at least a portion of at least one of the first and second identified ranges of values.

9. The computer implemented method of claim 8, further comprising removing the identified range of values over which a maintained index is generated from another identified range of values over which generation of a maintained index was advised.

10. The computer implemented method of claim 7, wherein determining whether to generate at least one maintained index over at least a portion of one of the first and second identified ranges of values includes amortizing at least one of the first and second identified ranges of values.

11. The computer implemented method of claim 10, further comprising utilizing an access plan cache to amortize at least one of the first and second identified ranges of values.

12. The computer implemented method of claim 8, further comprising reusing the generated maintained index to optimize a third database query.

13. An apparatus, comprising:
(a) a processor;
(b) a memory; and
(c) program code resident in the memory and configured to be executed by the processor to advise a range of values in a column in a table over which to generate a maintained index by identifying a range of values, wherein the range of values is a subset of values in a column of a table and advising generation of a maintained index over the identified range of values.

14. The apparatus of claim 13, wherein the table is a non-partitioned table, and wherein the program code is further configured to generate a maintained index over the identified range of values.

15. The apparatus of claim 14, wherein the program code is further configured to identify the range of values by analyzing a database query referencing the table, wherein the database query specifies the identified range of values.

16. The apparatus of claim 13, wherein the program code is further configured to advise generation of a maintained index over the identified range of values by performing generation analysis.

17. The apparatus of claim 13, wherein the program code is further configured to identify a second range of values, wherein the second range of values is a subset of values in the column of the table, and to advise generation of a maintained index over the identified second range of values.

18. The apparatus of claim 17, wherein the program code is further configured to identify the range of values by analyzing a second database query referencing the table, wherein the second database query specifies the identified second range of values.

19. The apparatus of claim 17, wherein the program code is further configured to determine whether to generate at least one maintained index over at least a portion of one of the first and second identified ranges of values based upon generation analysis.

20. The apparatus of claim 17, wherein the program code is further configured to generate a maintained index over at least a portion of at least one of the first and second identified ranges of values.

21. The apparatus of claim 20, wherein the program code is further configured to remove the identified range of values over which a maintained index is generated from another identified range of values over which generation of a maintained index was advised.

22. The apparatus of claim 19, wherein the program code is further configured to determine whether to generate at least one maintained index over at least a portion of one of the first and second identified ranges of values by amortizing at least one of the first and second identified ranges of values.

23. The apparatus of claim 20, wherein the program code is further configured to reuse the generated maintained index to optimize a third database query.

24. A program product, comprising:
(a) program code configured to advise a range of values in a column in a table over which to generate a maintained index by identifying a range of values, wherein the range of values is a subset of values in a column of a table and advising generation of a maintained index over the identified range of values; and
(b) a computer readable medium bearing the program code.

25. A computer implemented method of generating a maintained index over a range of values in a column in a table, the computer implemented method comprising:
a) determining a range of values in a column in a table over which to generate a maintained index, wherein the range of values is a subset of the values in the column; and
b) generating the maintained index over the identified range of values.
